(19) United States
(12) Patent Application Publication
(10) Pub. No.: US 2014/0062946 A1
(43) Pub. Date: Mar. 6, 2014

(54) SYSTEMS AND METHODS FOR ENHANCED DISPLAY IMAGES

(71) Applicants: David L. Graumann, Portland, OR (US); Jennifer Healey, San Jose, CA (US)

(72) Inventors: David L. Graumann, Portland, OR (US); Jennifer Healey, San Jose, CA (US)

(21) Appl. No.: 13/977,600

(22) PCT Filed: Dec. 29, 2011
(86) PCT No.: PCT/US2011/067848

§ 371 Date: Jun. 28, 2013

(51) Int. Cl. G06F 3/044

(52) U.S. Cl. CPC G06F 3/044
USPC 345/174

(57) ABSTRACT

Systems and methods for providing an enhanced image based on determining a proximal object is in proximity of a control panel. The enhanced image may be displayed on a heads up display of a vehicle.

### TECHNICAL FIELD

This invention generally relates to methods, systems, and apparatus for display images, and more particularly enhanced display images.

### BACKGROUND

Drivers of vehicles, such as cars, may need to control several components of the vehicle for purposes of safety, comfort or utility. As a result vehicles typically have several controls to control one or more components of the vehicle. Some common controls in vehicles may include, for example, radio controls, to set tuning or volume, heater controls to set the level of heat, and defroster controls to set the level of defrosting the windows of the vehicle.

Oftentimes, conventional controls on vehicles may be organized in clusters. For example, passenger cars may have a control panel between the driver's side and the passenger's side within the cab at the front of the cm where several control surfaces and interfaces are placed. Controls for the radio, navigation system, heater, air conditioner, and other components are often provided on the control panel.

The control panel, in many cases, may be crowded with controls due to the large number of components in modern vehicles that need to be controlled or otherwise require user interaction. Often times, the control panel may extend from the dashboard of the vehicle at its top to the transmission tunnel at its bottom to fit all the controls required on the vehicle. Some locations on the control panel may be more convenient and safer for a driver to reach than other locations on the control panel. Furthermore, the control panel and other control surfaces may be relatively crowded due to the large number of components that may need to be controlled in modern vehicles.

Typical control clusters and control surfaces on vehicles generally have a plurality of switches or other user input interfaces electrically coupled to electronic devices, such as a controller, via wiring to determine the switches or interfaces that are being actuated and translate the same to controllable functions. Therefore, the driver of a vehicle may have to reach over to the control cluster to actuate switches or other input and output interfaces. Given the location of the control clusters, such as the control panel, a driver may be looking at the control cluster to actuate the desired control interfaces while driving. Therefore, under certain circumstances, the driver may be distracted while driving the vehicle if the driver needs to control a component on the vehicle. The driver may look at the control cluster for a relatively extended period of time and not at the road, especially if the control cluster is crowded with a relatively high level of functionalities and controls. The control of components on a vehicle may, therefore, pose a safety issue for a driver, because the control of functions and components may be distracting during driving.

### BRIEF DESCRIPTION OF THE FIGURES

Reference will now be made to the accompanying drawings, which are not necessarily drawn to scale, and wherein:

FIG. 1 is a simplified top-down schematic view illustrating an example vehicle cockpit with vehicle controls and a display that can be operated in accordance with embodiments of the disclosure.

FIG. 2A is a simplified schematic diagram illustrating an example control panel of the vehicle of FIG. 1 operating in accordance with embodiments of the disclosure.

FIG. 2B is a simplified display output illustrating an example enhanced display of the control panel of FIG. 2A operating in accordance with embodiments of the disclosure.

FIG. 3 is a simplified side view schematic diagram of the example control panel of FIG. 2A illustrating the operation of the control panel in accordance with embodiments of the disclosure.

FIG. 4 is a graph illustrating an example charge vs. proximity relationship of the example control panel of FIGS. 2A and 3 in accordance with embodiments of the disclosure.

FIG. 5 is a simplified block diagram illustrating an example system for receiving sensor input from the control panel of FIG. 2A and an image sensor and providing display signals in accordance with embodiments of the disclosure.

FIG. 6 is a flow diagram illustrating an example method of providing display signals to display the control panel of FIG. 2A in accordance with embodiments of the disclosure.

### DETAILED DESCRIPTION OF EMBODIMENTS OF THE INVENTION

Embodiments of the invention are described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may provide systems, methods and apparatus for providing enhanced images of a control panel when an object is in proximity of the control panel. In certain embodiments, and image of the object may be overlaid over the enhanced image. In one aspect, the object, such as a person's finger, may be close to one of a plurality of control interfaces on the surface of the control panel, and the enhanced image may more prominently show an image of one or more control interfaces that are in proximity of the object. Therefore, the enhanced image as displayed to a user may provide a view of the control panel with the image of certain control interfaces enhanced relative to other control interfaces based on certain parameters, such its the relative distance of each of the control interfaces to the finger. The control panel may be in a vehicle setting, where a user may be trying to actuate one or more control interfaces on the control panel. A system may be provided to accept signals from sensors, such as signals from the control panel and/or from an image sensor, and determine the enhanced image signals based thereon. The enhanced image signal may be provided to a display device to display the corresponding enhanced image. The display may be a heads-up display or any other suitable display, such as one associated with the control panel, navigation system, or an in-vehicle infotainment system. Providing the enhanced image on a heads-up display in a vehicle may enable the user to actuate one or more controls of the vehicle without looking directly at the control panel. Therefore, the user may be able to continue looking at the road while driving and still be able to actuate the controls as required.

Example embodiments of the invention will now be described with reference to the accompanying figures.

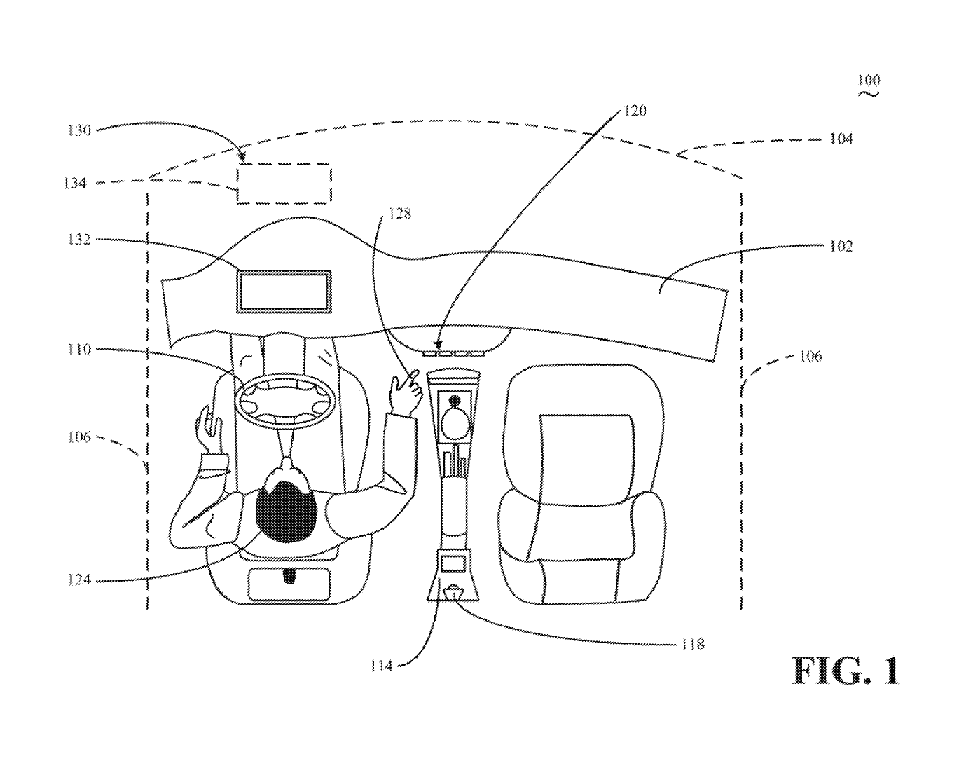

Referring now to FIG. 1, a vehicle cockpit 100 may include a dashboard 102, a windshield 104, side windows 106, a steering wheel 110, and a center arm rest 114. Situated on the center arm rest 114 may be an image sensor 118. Additionally, extending out from the dashboard 102 may be a control panel 120, such as a center console. A user of the vehicle, such as the driver 124, may wish to control components of the vehicle, such as a radio system or a heater, by actuating controls on the control panel 120 with an object, such as the driver's finger 128. The vehicle cockpit 100 may also include a display, such as a heads-up display (HUD) 130. The HUD 130 may further comprise a projector portion 132 and a display portion 134.

For the purposes of this discussion, the vehicle can include, but is not limited to, a car, a truck, at light-duty truck, a heavy-duty truck, a pickup truck, a minivan, a crossover vehicle, a van, a commercial vehicle, a private vehicle, a sports utility vehicle, a tractor-trailer, an aircraft, an airplane, a jet, a helicopter, a space vehicle, a watercraft, or any other suitable vehicle having a relatively closed cockpit. However, it will be appreciated that embodiments of the disclosure may also be utilized in other environments where control of components may be implemented.

It should also be noted that although control elements of the vehicle are shown as a center console, control panels, or even single controls, may be provided on any of the surfaces of the interior of the vehicle. For example, a control surface may be provided on any one of the dashboard 102, the steering wheel 110, the center arm rest 114, a door (not shown), or the like.

The image sensor 118 may be any known device that converts an optical image or optical input to an electronic signal. The image sensor 118 may be of any known variety including a charge-coupled device (CCD), complementray metal oxide semiconductor (CMOS) sensors, or the like. The image sensor 118 may be of any pixel count and aspect ratio. Furthermore, the image sensor 118 may be sensitive to any frequency of radiation, including infrared, visible, or near-ultraviolet (UV).

The projector portion 132 of the HUD 130 may provide an image that is not viewed directly by the driver 124, but may be reflected off of another surface, such as the display portion 134 for viewing by the driver 124. In one aspect, the display portion 134 may be a portion of the windshield 104 on which the image generated by the projector portion 132 is reflected and viewed by the driver 124. Therefore, the display portion 134 may be in the line of sight of the driver 124 when the driver is looking out of the windshield 104 at the road. In one aspect, viewing a display on the display portion 134 may not require the driver 124 to stop viewing the road on which the vehicle is traveling. In yet another aspect, viewing a display on the display portion 134 may not require the driver 124 to view the road on which the vehicle is traveling using only peripheral vision. The projector portion 132 may generate an image in an orientation which when reflected off of the display portion 134 and observed by the driver 124, the image is of the correct orientation.

The projector portion 132 may be any suitable type of display including, but not limited to a touch screen, a liquid crystal display (LCD), a thin-film transistor (TFT) display, and organic light-emitting diode (OLED) display, a plasma display, a cathode ray tube (CRT) display, or combinations thereof. In one aspect, the display portion 134 may receive display signals and based upon the display signals provide still or moving images corresponding to the display signals. In another aspect, the images displayed on the display portion 134 may be viewed by one or more users, such as the driver 124 of the vehicle.

It should be appreciated that certain embodiments may provide displays other than the HUD 130 within the vehicle cockpit 100. For example, a display may be provided extending from the dashboard 102 that can be viewed by the driver 124 with minimal head movement and relatively little distraction from viewing the road and driving.

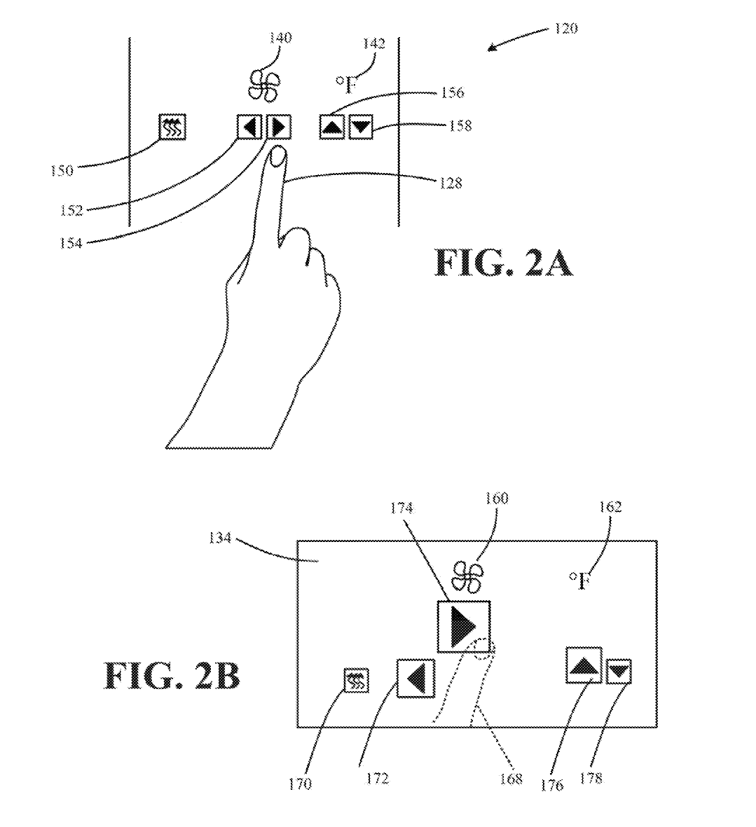

Referring now to FIG. 2A, the control panel 120 in accordance with embodiments of the disclosure may include one or more icons 140 and 142 provided thereon. The control panel 120 may further include a plurality of control interfaces 150, 152, 154, 156, and 158 that in conjunction with the one or more icons 140 and 142 provide the driver 124 with information regarding the functionality and/or the components that can be controlled by actuating each of the plurality of control interfaces 150, 152, 154, 156, and 158. For example, the icon 140 may indicate that the control interlaces 152 and 154 may pertain to controlling a fan providing, air to the vehicle cockpit 100. Similarly, icon 142 may indicate that control interfaces 156 and 158 may control the temperature within the vehicle cockpit 100 by controlling, for example, a heater or at conditioner of the vehicle. Some control interfaces, such as defrost control interface 150, may not have an icon associated therewith.

The driver 124 may actuate one or more of the control interfaces 150, 152, 154, 156, and 158 by touching or depressing a control interface with the finger 128. In certain embodiments, the control interfaces 150, 152, 154, 156, and 158 may be touch controls that can be actuated by touching and without depressing any elements. In other embodiments, the control interfaces 150, 152, 154, 156, and 158 may be physical switches, such as toggle switches, that can be depressed by the driver 124 using his or her finger 128. In yet other embodiments, the control interfaces 150, 152, 154, 156, and 158 may be a touch controls with a physical element that can be depressed to provide a tactile feedback to the driver 124 when actuated. Touch controls may be of any known type, including, but not limited to, capacitive touch screens, resistive touch screens, infrared touch screens, or combinations thereof. In certain embodiments, the control interfaces 150, 152, 154, 156, and 158 may be capacitive touch screens, such as a capacitive panel, that can not only detect contact with the finger 128, but can also detect that the finger 128 is in relatively close proximity. Therefore, such a control panel with capacitive-touch screen-based control interfaces 150, 152, 154, 156, and 158 may generate a signal that indicates both or either of contact with the finger 128 or that the finger 128 is in relatively close proximity of one or more of the control interfaces 150, 152, 154, 156, and 158.

Referring now to FIG. 2B, an example enhanced image displayed on the display 130 in accordance with embodiments of the disclosure, is illustrated. The enhanced image may include images of the icons 160 and 162, corresponding to the icons 140 and 142 of FIG. 2A, respectively, as well as images of the control interlaces 170, 172, 174, 176, and 178, corresponding to the control interfaces 150, 152, 154, 156, and 158 of FIG. 2A, respectively. In addition, the enhanced image may include an image of the finger 168, corresponding to the finger 128 of FIG. 2A.

In certain embodiments, the control interfaces 150, 152, 154, 156, and 158 most proximal to the finger 128 may be displayed more prominently than the other control interfaces 150, 152, 154, 156, and 158 in the enhanced display image as displayed on the display 130. For example, as depicted in FIG. 2A, the fan right arrow 154 may be more proximal to the finger than the other control interfaces 150, 152, 156, and 158. Accordingly, the image of the fan right arrow 174, corresponding to the fan right arrow control interface 154 in FIG. 2A, may be displayed more prominently in the enhanced display image as displayed on the display 130. When viewed by a user, such as the driver of the vehicle 124, the driver 124 may notice the image of the fan right arrow 174 more readily than the it of the defroster 170, the image of the fan left arrow 172, the image of the temperature up arrow 176, or the image of the temperature down arrow 178. As depicted, the prominence of one image of control interface 170, 172, 174, 176, and 178 relative to another image of control interfaces 170, 172, 174, 176, and 178 may be provided by making the relatively more prominent image of the control interface larger than the images of the other relatively less prominent control interfaces. In other words, the area of an image of a more prominently displayed control interface may be greater than the area of the image of a less prominently displayed control interface.

With reference to the depictions of FIGS. 2A and 2B, where the finger 128 is most proximal to the fan right arrow control interface 154, the corresponding image of the fan right arrow control interface 174 may be depicted with a larger size on the display 130, than the other images of control interfaces 170, 172, 176, and 178. Therefore, based on the enhanced image, as displayed on display 130, the driver 124 may be aware by viewing the enhanced display image that his/her finger 128 is closest to the fan right arrow control interface 154 relative to the other control interlaces 150, 152, 156, and 158, without having to look at the control panel. Since the HUD 130, and particularly the display portion 134, may provide the enhanced image directly in front of the driver 124, such as on the windshield 104, the driver may not have to look away from the road to be able to know the location of his/her finger 128 relative to the control panel 120 and its constituent elements 140, 142, 150, 152, 154, 156, and 158. In one aspect, the driver 124 can see the location of his/her finger 128 relative to the surface of the control panel 120 at the driver 124 moves his/her finger 128 in proximity to the control interfaces 150, 152, 154, 156, and 158 on the control panel 120. In another aspect, the driver may be able to see the location of the finger 128 relative to the surface of the control panel 120 on the HUD 130 while, contemporaneously viewing the road and the general environment outside of the vehicle cockpit 100. Therefore, it may be safer for the driver 124 to use the enhanced display image as shown on the HUD 130 for the purpose of awareness of the location of his/her finger 128, rather than looking directly at the control panel 120. The location of the control panel 120, may cause the driver 124 to view the road only using peripheral vision or not view the road at all.

In certain embodiments, the enhanced image as shown on the HUD 130 may also include an image of the finger 168, corresponding to the driver's 124 finger 128. Therefore, the driver 124 may be made aware of the location of his/her finger 128, not only by enhancements to the images of each of the control interfaces 170, 172, 174, 176, and 178, bat also by the overlaid image of his/her finger 168. The overlaid image of the finger 168 may be semi-transparent. In other words, it may be possible to view images of the icons 160 and 162 or images of the control interfaces 170, 172, 174, 176, and 178 through the image of the finger 168. Therefore, the driver 124 may be provided with an awareness of the location of the finger 128 relative to the control interfaces 150, 152, 154, 156, and 158, without blocking the view of the images of the control interfaces 170, 172, 174, 176, and 178 on the enhanced image as displayed on the HUD 130.

In certain other embodiments, the image of the finger 168 on the enhanced image as displayed on the HUD 130 may not be transparent. In one aspect, the image of the finger 168 may be opaque and therefore block the image of control interfaces 170, 172, 174, 176, and 178 on which it is overlaid. In yet other embodiments, the image of the finger 168 may either be translucent or opaque and be shown intermittently. In other words, the image of the finger 168 may be shown for a first period of time and then not shown for a second period of time. In one aspect, the image of the finger 168 may appear to flicker when displayed on the HUD 130 if shown intermittently.

In certain embodiments, the image of the finger 168 may be in the likeness of the driver's finger 128. In other words, the size, shape, and other features of the image of the finger 168 may be different for different drivers and based on the size, shape, and other features of the finger 128. In other embodiments, the image of the finger 168 may be a generic image that may or may not have any resemblance to the driver's finger 128. In other words, the size, shape, and other features of the image of the finger 168 may be the same for different drivers and not directly based on the size, shape, and other features of the finger 128.

In certain embodiments, the prominence of one or more of the images of control interfaces 170, 172, 174, 176, and 178 may be conveyed by placing the prominent image of the control interface at a location that is different from the location of the images of the other control interfaces. For example, when the finger 128 is most proximal to the fan right arrow control interface 154, the corresponding image of the fan right arrow control interface 171 may be depicted at a different location on the display 130 than the other images of control interfaces 170, 172, 176, and 178. Accordingly, as illustrated, the image of the fan right arrow control interlace 174 may be relatively raised, or closer to the top of the display portion 134 relative to the other images of control interfaces 170, 172, 176, and 178. It will be appreciated that prominence of an image of a control interface relative to the image of other control interlaces 170, 172, 174, 176, and 178 may be conveyed using any combination of varying size or varying locations.

In certain embodiments, there may be varying level of prominence of each of the images of the control interfaces 170, 172, 174, 176, and 178. The level of prominence may be accorded based on the distance between the finger 128 and each of the control interfaces 150, 152, 154, 156, and 158 corresponding to the images of the control interfaces 170, 172, 174, 176, and 178. Therefore, in an enhanced image that is in accordance with the particular embodiments, not only is the image of the most proximal control interlaces 150, 152, 154, 156, and 158 made prominent, but all of the images of control interfaces 170, 172, 174, 176, and 178 have a varying level of prominence. As in other embodiments, prominence of one image of control interface 170, 172, 174, 176, and 178 relative to another image of control interfaces 170, 172, 174, 176, and 178 may be provided by making the relatively more prominent image of the control interface larger than the images of the other relatively less prominent control interfaces. For example, with the scenario shown in FIGS. 2A and 2B, the image of the fan right arrow control interface 174 may be of a larger size than the fan left arrow control interface 172, which in turn may be a larger size than the image of the temperature up arrow 176, which in turn may be of a larger size than the image of the defroster 170 and the image of the fan down arrow 178.

In yet other embodiments, the prominence of one image of control interface 170, 172, 174, 176, and 178 relative to another image of control interfaces 170, 172, 174, 176, and 178 may be provided by making the relatively more prominent image of the control interface have a different color, a halo, a different halo relative to other images, a vibration, a different vibration relative to other images, a shading, a different shading relative to other images, a flashing, a different flashing relative to other images, or combinations thereof. It will be appreciated that the enhanced image as displayed on the display portion 134 of the HUD 130, may have any combination of the mechanisms for conveying prominence to the driver 124 of one or more images of the control interfaces 170, 172, 174 176, and 178 relative to the other of the one or more images of control interfaces 170, 172, 174, 176, and 178.

In one aspect, if the finger 128 touches one or more of the control interfaces 150, 152, 154, 156, and 158, the same may be indicated on the enhanced image. The indication may be in the form of providing prominence to the images of the control interfaces 170, 172, 174, 176, and 178 corresponding to the touched control interfaces 150, 152, 154, 156, and 158. The prominence may be in the form of highlighting, providing color to, or oscillating the image of the control interfaces 170, 172, 174, 176, and 178 corresponding to the touched control interfaces 150, 152, 154, 156, and 158.

It should also be noted that the enhanced image as displayed on the HUD 130 may be a moving image. In other words, a new image may be produced and displayed on the HUD 130 at some predetermined frequency, called a refresh rate. For example, the refresh rate may be about 60 frames per second. As such, the image of the control interface may change with time as the finger 128 moves from one location proximate to a first control interface 150, 152, 154, 156, and 158 corresponding to a first image of the control interface 170, 172, 174, 176, and 178 to another location that is proximate to a different control interface 150, 152, 154, 156, and 158 that corresponds with a different image of a control interface 170, 172, 174, 176, and 178.

Although only five control interfaces arranged in a single row (150, 152, 154, 156, and 158 with associated images 170, 172, 174, 176, and 178) were shown for illustrative purposes, it should be appreciated that there may be any number of control interfaces associated with any number of components and controls on the vehicle and arranged in any variety of configurations on the control panel 120.

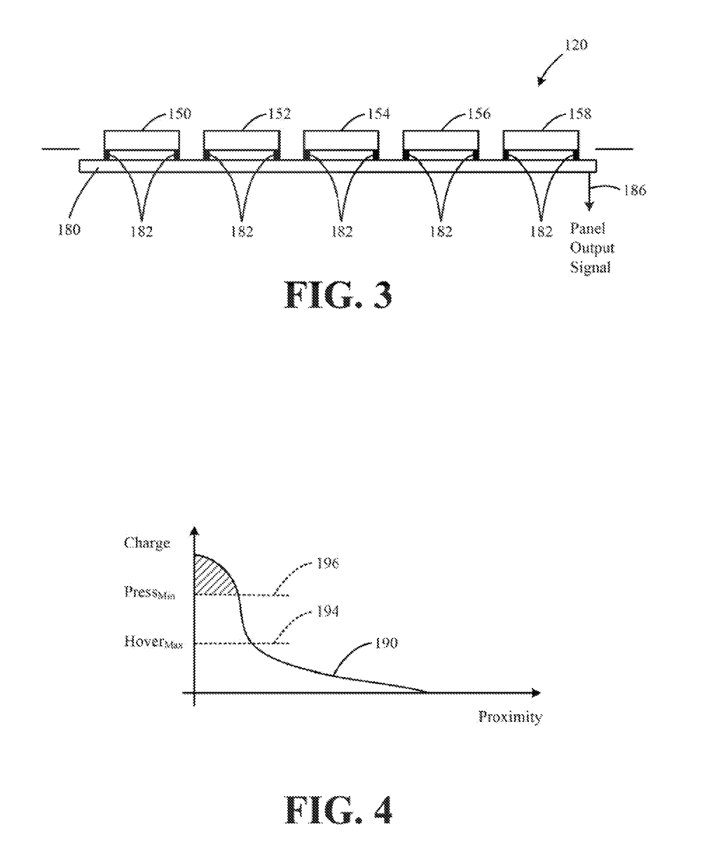

Referring now to FIG. 3, the functioning of the example control panel, in the form of the control panel 120, is discussed. As stated earlier, the control panel 120 may be a touch sensitive panel with elements that provide a tactile feedback to the user. For example, the touch sensitive panel may be a capacitive panel 180, as depicted, and each of the control interfaces 150, 152, 154, 156, and 158 may be supported on the capacitive panel 180 with a spacer 182. The capacitive panel 180 may further have a panel output port 186 that is configured to provide a panel output signal based in part on movement of objects near or the actuation of one or more of the control interfaces 150, 152, 154, 156, and 158.

The capacitive panel may have a plurality of capacitive cells (not shown) of any shape and size that can have a varying charge associated therewith. The charge on each cell may vary based on proximity of the finger 128 near one or more of the cells and the variation in charge is indicated in the panel output signal as provided via panel output port 186. In other words, a conductive element, such as the finger 128, may be able to perturb the charge on one or more capacitive cells of the capacitive panel when proximate to those cells. Therefore, the capacitive panel signal can indicate the region on the capacitive panel 180 where an object, such as the finger 128, is near. The functioning of capacitive panels 180 are well-known, and in the interest of brevity, will not be reviewed here.

In certain embodiments, each of the control interfaces 150, 152, 154, 156, and 158 may be constructed from electrically conductive materials, such as any variety of metals or semi-metals. As a result, when the finger 128 comes in proximity of the control interfaces 150, 152, 154, 156, and 158, the control interfaces 150, 152, 154, 156, and 158 may serve as an extension to the control panel. Therefore, although the finger 128 may be relatively far from the surface of the capacitive panel 180, the finger 128 may still be able to perturb the charges on cells of the capacitive panel 180 via the conductive control interfaces 150, 152, 154, 156, and 158. Further, when the finger actuates one of the control interfaces 150, 152, 154, 156, and 158, the control interfaces 150, 152, 154, 156, and 158 may come in physical contact with the surface of the capacitive panel 180. The physical contact may be due to either or both of compression of the spacers 182, or elastic deformation of the control interfaces 150, 152, 154, 156, and 158 during actuation by the finger 128. The physical contact between the control interfaces 150, 152, 154, 156, and 158 and the capacitive panel 180 may be indicated by the panel output signal.

The spacers 182 may, in one aspect, be compressible materials that can allow for movement or their respective control interfaces 150, 152, 154, 156, and 158 toward the capacitive panel 180 when the control interface is actuated by, for example, the finger 128. Therefore, the spacers 182, may enable a tactile feedback to the driver 124 when one or more of the control interfaces 150, 152, 154, 156, and 158 are actuated using the finger 128 belonging to the driver 124. In other words, the spacers may provide the ability for the control interfaces 150, 152, 154, 156, and 158 to have the look and feel of buttons that can be depressed with the finger 128 to effect an actuation. Such interfaces and tactile feedback may be preferred by some consumers, such as the driver 124, compared to interfaces with no or limited haptic feedback, such as capacitive panels 180 without the compressible spacers 182. In certain embodiments, the spacers 182 may further be electrically conductive. For example, the spacers 182 may be constructed from any variety of metals.

Referring now to FIG. 4, an example charge 190 versus object proximity relationship of a cell of the capacitive panel 180 is shown to illustrate how the signal may be interpreted to detect a finger 128 generally in proximity of the capacitive panel 180 of the control interfaces 150, 152, 154, 156, and 158 mounted thereon. The panel output signal provided from the panel output port 186 may be indicative of the charge versus proximity relationship as shown. Because the finger 128 is relatively distal from the control interfaces 150, 152, 154, 156, and 158, the charge may be at a relatively low level. As the finger 128 moves closer to the control interfaces 150, 152, 154, 156, and 158, the charge level may increase. A predetermined charge level may be indicative of a maximum hover level 194 (Hover_{Max}), or a maximum charge level, at or below which the charge level is indicative of the finger 128 hovering near, or generally being in proximity of, the control interfaces 150, 152, 154, 156, and 158. In other words, a non-zero charge level below the Hover_{Max} 194 may be interpreted by a controller as the finger 128 being in proximity of the control interfaces 150, 152, 154, 156, and 158, but not touching it.

Another predetermined charge level may be indicative of a minimum “press” or actuation level 196 (Press_{MIN}), or a minimum charge level, at or above which the charge level is indicative of the finger 128 touching, pressing, or otherwise actuating the control interfaces 150, 152, 154, 156, and 158. The charge level between Hover_{MAX} 194 and Press_{MIN} 196 may be a “debouncing zone” or a charge level that may or may not be indicative of the finger actuating a particular control interface 150, 152, 154, 156, and 158 depending on noise in the system. In other words, the debouncing zone may be a charge level that may be indicative of the finger pressing the control interfaces 150, 152, 154, 156, and 158, but may not with a level of confidence to be relatively certain that an actuation of the control interfaces 150, 152, 154, 156, and 158 was made or was intended.

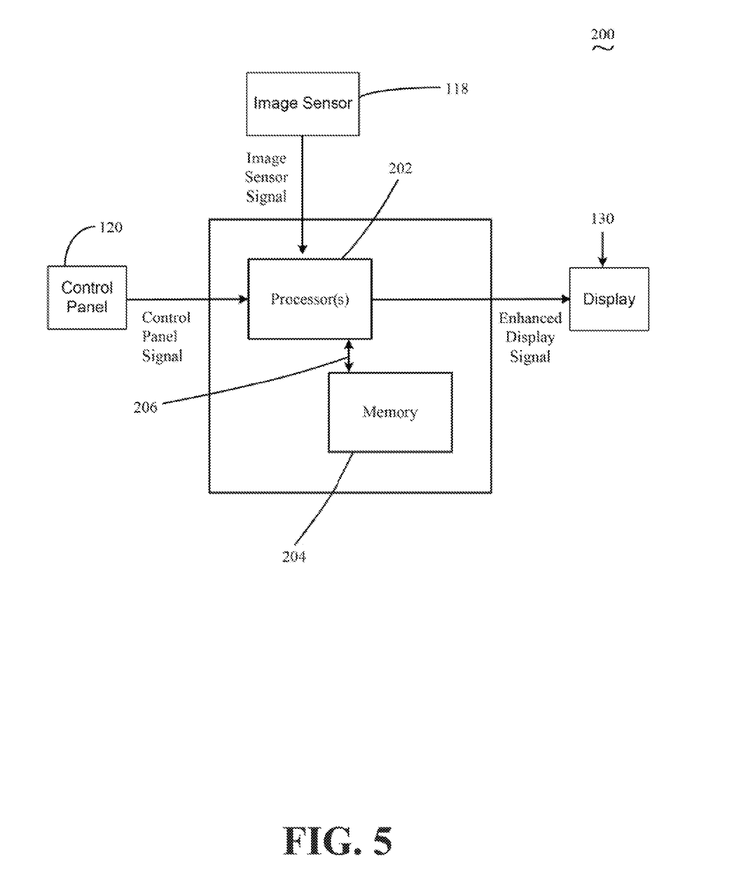

Referring now to FIG. 5, an example system 200 for providing the enhanced image signal related to the control panel 120, in accordance with embodiments of the disclosure, is illustrated. The system 200 may include one or more processors 202 communicatively coupled to an electronic memory 204 via as communicative link 206. The one or more processors 202 may further be communicatively coupled to the image sensor 118 and receive image sensor signals generated by the image sensor 118. Additionally, the one or more processors 202 may be communicatively coupled to the control panel 120 and receive control panel signals generated by the control panel 120.

The one or more processors 202 may include, without limitation a central processing unit (CPU), a digital signal processor (DSP), a reduced instruction set computer (RISC), a complex instruction set computer (CISC), a microprocessor, a microcontroller, at field programmable gate army (FPGA), or any combination thereof. The system 200 may also include a chipset (not shown) for controlling communications between the one or more processors 202 and one or more of the other components of the system 200. In certain embodiments, the system 200 may be based on an Intel® Architecture system and the processor(s) 202 and chipset may be from a family of Intel®, processors and chipsets, such as the Intel® Atom® processor family. The one or more processors 202 may also include one or more application-specific integrated circuits (ASICs) or application-specific standard products (ASSPs) for handing specific data processing functions or tasks.

The memory 204 may include one or more volatile and/or non-volatile memory devices including, but not limited to, random access memory (RAM), dynamic. RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

In certain embodiments, the one or more processors 202 may be part of an in-vehicle infotainment (IVI) system. In other embodiments the one or more processors 202 may be dedicated to the system 200 for providing enhanced images related to the control panel 120. Therefore, in such embodiments, the system 200 is separate from the IVI system. However, the system 200 may optionally communicate with the IVI system of the vehicle.

During operation, the one or more processors 202 may generate display signals that are provided to a display, such as the HUD 130, based at least in part on the received image sensor signals and the control panel signals. In one aspect, the display signals may correspond to a display image that may be shown on the HUD 130. In certain embodiments, the display image may be an enhanced display image of the image corresponding to the image sensor signals provided by the image sensor 118. The enhancement associated with the enhanced display image may entail rendering one or more of the images of the control interfaces 170, 172, 174, 176, and 178 differently from the other images of the control interfaces 170, 172, 174, 176, and 178. For example, the rendering of one of the images of the control interfaces 170, 172, 174, 176, and 178 may entail a different size, different location, different color, an oscillation, a different frequency of oscillation, a different magnitude of oscillation, a surrounding halo, a different size of a surrounding halo, a different color of a surrounding halo, a disproportionate size, a different level of pixel dithering, or combinations thereof relative to other images of the control interfaces 170, 172, 174, 176, and 178. Therefore, in the enhanced display image one or more of the images of the control interfaces 170, 172, 174, 176, and 178 may be displayed more prominently than the other images of the control interfaces 170, 172, 174, 176, and 178. In other words, the driver 124 viewing the enhanced display image may notice one or more of the images of the control interfaces 170, 172, 174, 176, and 178 more readily than some of the other images of the control interfaces 170, 172, 174, 176, and 178.

In certain embodiments, the one or more processors 202 may access a fixed image file stored on the electronic memory 204. The fixed image file may be an image of the face of the control panel 120 with constituent images of the icons 160 and 162 and the images of control interfaces 170, 172, 174, 176, and 178. In one aspect, the one or more processors may ascertain based on the control panel signal, the location of an object, such as the occupant's finger 128. Based on the location of the finger, the one or more processors 202 may modify the fixed image to generate the enhanced display image. The modification can entail making one or more of the images of the control interfaces 170, 172, 174, 176, and 178 more prominent relative to the other images of the control interfaces 170, 172, 174, 176, and 178, based upon the determined location of the finger. Furthermore, the image of the 168 may be overlaid on the modified image to generate the enhanced display image. The image of the finger 168 may be a fixed image of the finger 168 and stored in the electronic memory 204 and accessed by the one or more processors as needed for the generation of the enhanced display image. It can be seen that in such embodiments, the image sensor signals provide input to the one or more processors 202 and, therefore, the image sensor 118 may be optional.

In certain other embodiments, one or more processors 202 may generate the image of the finger 168 in the likeness of the actual finger based in part on the image sensor signal. Therefore, the image of the finger 168 may not be a fixed image of the finger 168 and is dynamically generated during use of the system 200 by the one or more processors 202. It can be seen that in such embodiments, the control panel signals may be utilized by the one or more processors 202 to determine the location of the finger 128 and the image sensor signals may be utilized by the on or more processors 202 to render an image of the finger 168.

In yet other embodiments, the one or more processors 202 may utilize the control panel signals to ascertain the location of the finger 128. However, when the finger 128 is not in relatively close proximity to the control panel 120 to be indicated in the control panel signal, the one or more processors 202 may utilize the image sensor signals to ascertain the location of the finger 128. In one aspect, the one or more processors 202 may analyze the image corresponding to the received image sensor signal, such as in a frame-by-frame basis, to identify the image of the finger, and then determine the location of the finger based upon identifying the location of the one or more control interfaces 150, 152, 154, 156, and 158. Based on the location of the finger, the one or more processors 202 may modify the fixed image to generate the enhanced image file. The modification can entail making one or more of the images a the control interfaces 170, 172, 174, 176, and 178 more prominent relative to the other images of the control interfaces 170, 172, 174, 176, and 178 based upon the determined location of the finger. It can be seen that in such embodiments, either the image sensor signals, the control panel signals, or both may be used to ascertain the location of the finger 128 relative to the control panel 120.

In yet further embodiments, the one or more processors 202 may generate an initial image file of the control panel. The initial image file may be an image of the face of the control panel 120 with constituent images of the icons 160 and 162 and the images of control interfaces 170, 172, 174, 176, and 178. In one aspect, the one or more processors may ascertain based one or both of the control panel signal and the image sensor signal, the location of the finger 128. Based cm the location of the finger, the one or more processors 202 may modify the initial image file to generate the enhanced image file. The modification can entail making one or more of the images of the control interlaces 170, 172, 174, 176, and 178 more prominent relative to the other images or the control interfaces 170, 172, 174, 176, and 178, based upon the determined location of the finger. It can be seen that in such embodiments, either the image sensor signals, the control panel signals, or both may be used to ascertain the location of the finger 128 relative to the control panel 120.

It will be appreciated that in certain embodiments, the image sensor signal, the control panel signal, or both may provide information at a frequency that enables the one or more processors 202 to generate and enhanced display image at a frequency that provides for an acceptable level of time lag between movement of the finger and the indication of the same on the HUD 130. A relatively short time lag may lead to an enjoyable user experience of the system 200.

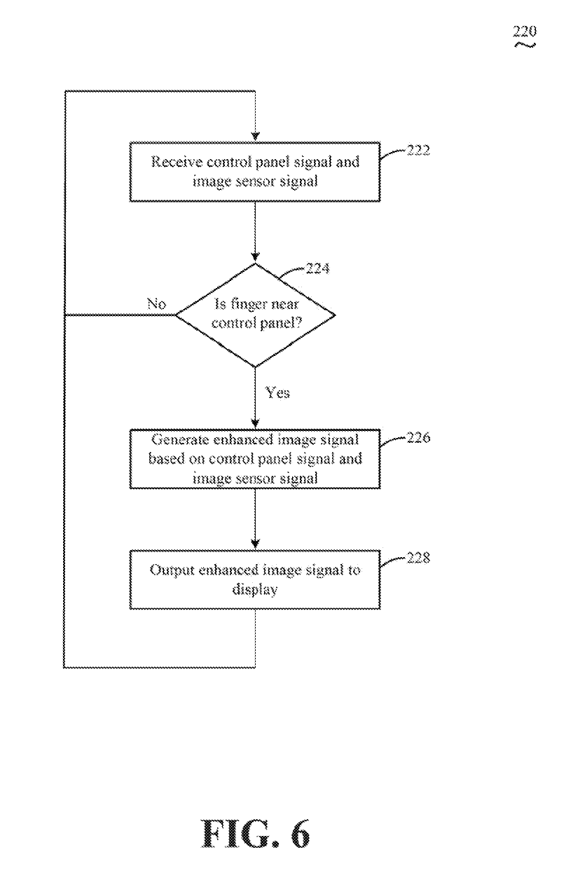

Referring now to FIG. 6, a method 220 for displaying an enhanced display image is disclosed.. At block 222, image sensor signals and the control panel signals are received. As described with reference to FIGS. 3 and 5, the image sensor signals and the control panel signals by themselves, or in combination, may be indicative of the location of an object, such as the finger 128 relative to the control panel, such as the control panel 120.

At block 224, it is determined if the finger 128 is near the control panel. The determination may be based on one or both of the image sensor signal or the control panel signal. As discussed in reference to FIG. 5, the one or more processors 202 may analyze the received signals to determine the relative proximity of the finger 128 to the control panel 120. If it is determined that the finger 128 is not near the control panel, then the method 270 may return to block 722, and continue to receive input from the image sensor 118 and the control panel 120.

If at block 224, it is determined that the finger 128 is in proximity of the control panel 120, then at block 226, an enhanced display image signal may be generated based on the input from the control panel 120 and the image sensor 118. The details of generating the enhanced image signal were described with reference to FIG. 5. The generation of the enhanced image signal may entail the one or more processors 202 ascertaining the location of the finger 128 relative to the control panel 120 and portraying one or more elements, such as the control interfaces 150, 152, 154, 156, and 158 of the control panel 120, more prominently than the other elements. In addition, the one or more processors 202 may overlay the image of the finger on the image of the control panel to generate the enhanced image. At block 228, the enhanced image signal is provided to the display, such as the HUD 130, to display the enhanced image.

It should be noted, that the method 220 may be modified in various ways in accordance with certain embodiments of the disclosure. For example, one or more operations of the method 220 may be eliminated or executed out of order from the other embodiments of the disclosure. Additionally, other operations may be added to the method 220 in accordance with other embodiments of the disclosure.

Embodiments described herein may be implemented using hardware, software, and/or firmware, for example, to perrorm the methods and/or operations described herein. Certain embodiments described herein may be provided as a tangible machine-readable medium stating machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), magneto-optical disks, semiconductor devices such as read-only memories (ROMs), random access memories (RAMs) such as dynamic and static RAMs, erasable programmable read-only Memories (EPROMs), electrically erasable programmable read-only memories (EEPROMs), flash memories, magnetic or optical cards, or any type of tangible media suitable for storing electronic instructions. The machine may include any suitable processing or computing platform, device, or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described for portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited, to the disclosed embodiments, but on the contrary, is intended to over various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method comprising:
receiving, by at least one processor, a signal from a control panel configured to sense a proximal object;
determining, by the at least one processor, the proximal object is in proximity of the control panel based at least in part on the signal;
generating, by the at least one processor, based at least in part on determining the proximal object is in proximity of the control panel, an enhanced image signal corresponding to an enhanced image; and,
providing by the at leant one processor, the enhanced image signal to a display.

2. The method of claim 1, wherein the control panel comprises a capacitive panel.

3. The method of claim 1, wherein the signal is indicative of a region on the control panel where the proximal object is most proximal.

4. The method of claim 1, wherein the proximal object comprises a finger.

5. The method of claim 1, wherein the determining the proximal object is in proximity of the control panel further comprises sensing a change in a voltage level of the signal.

6. The method of claim 1, wherein the generating an enhanced image signal, by the at least one processor, further comprises receiving an image signal from an image sensor.

7. The method of claim 6, wherein the enhanced image comprises an image of the proximal object overlaid on an image of the control panel based at least in part on the image signal.

8. The method of claim 7, wherein the image of the proximal object is translucent compared to the image of the control panel.

9. The method of claim 7, wherein the image of the control panel comprises images of at least one control interface, each image of the at least one control interface corresponding to a respective control interface on the control panel.

10. The method of claim 9, wherein an area of one of the image of the at least one control interface is greater than the area of the image of the other of the at least one control interface.

11. The method of claim 9, wherein the an area of the image of one of the at least one control interface that is closest to the proximal object is greater than the area of the image of the other of the at least one control interface that are more distal from the proximal object.

12. The method of claim 1, wherein the display is a heads-up display.

13. The method of claim 1, wherein the display, based in part on the enhanced image signal, displays the enhanced image.

14. The method of claim 1, wherein the display, the at least one processor, and the control panel are provided on a vehicle.

15. The method of claim 1, further comprising detecting a force between the proximal object and the control panel exceeding a predetermined threshold.

16. The method of claim 15, further comprising detecting a region on the control panel corresponding to the contact.

17. A system comprising;
a control panel configured to sense a proximal object and provide a control panel signal indicative of the sensing the proximal object;
an image sensor configured to provide an image sensor corresponding to an image of the control panel and an image of the proximal object;
at least one processor configured to receive the control panel signal and the image sensor signal and generate an enhanced image signal corresponding to an enhanced image; and,
a display configured to receive the enhanced image signal and display the enhanced image.

18. The system of claim 17, wherein the control panel further comprises a capacitive panel.

19. The system of claim 18, wherein the control panel further comprises at least one electrically conductive control interface in proximity of the capacitive panel.

20. The system of claim 17, wherein the image of the control panel comprises images of at least one control interface, each image of the at least one control interface corresponding to a respective control interface on the control panel.

21. The system of claim 20, wherein an area of the image of one of the at least one control interface is greater than the area of the image of the other of the at least one control interface.

22. The system of claim 20, wherein the an area of the image of one of the at least one control interfaces that is closest to the proximal object is greater than the area of the image of the other of the at least one control interface that are more distal from the proximal object.

23. The system of claim 17, wherein the signal is indicative of a region on the control panel where the proximal object is most proximal.

24. The system of claim 17, wherein the proximal object comprises an object that provides an electrical path to ground.

25. The system of claim 17, wherein the display is a heads-up display.

26. At least one computer readable medium comprising computer-executable instructions that, when executed by one or mote processors, execute a method comprising:
receiving a signal from a control panel configured to sense a proximal object;
determining the proximal object is in proximity of the control panel based at least in part on the signal;
generating based at least in part on the determining the proximal object is in proximity of the control panel, an enhanced image signal corresponding to an enhanced image; and,
providing the enhanced image signal to a display.

27. The computer readable medium of claim 26, wherein the image of the control panel comprises images of at least one control interface, each image of the at least one control interface corresponding to a respective control interface on the control panel.

28. The computer readable medium of claim 27, wherein an area of the image of one or the at least one control interlace is greater than the area of the image of the other of the at least one control interface.

29. The computer readable medium of claim 27, wherein the an area of the image of one of the at least one control interface that is closest to the proximal object is greater than the area of the image of the other of the at least one control interface that are more distal front the proximal object.
